(19) United States
(12) Patent Application Publication
(10) Pub. No.: US 2026/0304311 A1
(43) Pub. Date: Oct. 1, 2026

(54) NF DEVICE, TERMINAL DEVICE, AND POWER OPTIMIZATION METHOD PERFORMED FOR NF

(71) Applicant: SK TELECOM CO., LTD., Seoul (KR)

(72) Inventors: Hyung Du CHOI, Seoul (KR); Dong Jin LEE, Seoul (KR); Seong Jun LEE, Seoul (KR)

(21) Appl. No.: 19/489,411

(22) PCT Filed: May 30, 2024
(86) PCT No.: PCT/KR2024/007368

§ 371 Date: Dec. 2, 2025

(30) Foreign Application Priority Data
Jun. 2, 2023 (KR) 10-2023-0071591

(51) Int. Cl. H04W 52/02

(52) U.S. Cl. CPC H04W 52/0203

(57) ABSTRACT

The present invention presents a technical configuration enabling dynamic power saving through the configurations of: sharing information (power information (PI)) about performance and the like, including wattage between NFs (for example, UENF, RANF, AMF, SMF, UPF, . . . ); and using the PI of each NF during selection of an NF and a service producer, and executing a power mode command (PMC) on the basis of the power information when necessary.

### TECHNICAL FIELD

The disclosure relates to a technology capable of optimizing power and resources of a network function (NF).

The present application claims the priority of Application No. 10-2023-0071591, filed on Jun. 2, 2023, and the entire content of the application is incorporated herein by reference for all purposes.

### BACKGROUND ART

In B5G/6G networks, a large number of network functions (NFs) exist, and a large amount of signaling is generated by communications processed based on a service-based interface (SBI) protocol between NFs.

Terminals, base stations, and core equipment of B5G/6G are evolving into virtualization and cloud-native NFs (CNFs). Accordingly, CNFs are implemented so as to be easily loaded and operated in a common HW pool (general-purpose server).

Recently, as environmental, social, and governance (ESG) factors have gained importance, power reduction and optimization have become essential elements in B5G and 6G communication equipment.

As part of this, various technologies have been developed in recent general-purpose servers to reduce power consumption, and functions for real-time power control have been commercialized to a considerable extent. For example, via a function of dynamically adjusting a CPU frequency according to a CPU load, energy consumption of common HW can be changed or adjusted in real time.

However, in the role of efficiently managing/controlling/distributing (and adjusting) resources in terminals, base stations, and core systems, power consumption cannot be considered as a criterion. Accordingly, there are various requirements for energy (i.e., power amount=wattage).

However, in B5G/Pre6G mobile communication standards, there are no discussions/measures regarding sharing of wattage, and this has merely been left as the responsibility of equipment manufacturers or communication operators, which is a limitation.

Accordingly, the present disclosure proposes a new technical solution capable of achieving ESG by optimizing power and resources of each NF via power information sharing between NFs, thereby improving various problematic situations caused by the absence of measures in the current standards.

### DISCLOSURE OF INVENTION

### Technical Problem

The task to be achieved in the present disclosure is to implement a technical solution that enables optimization of power and resources of each NF via power information sharing between NFs.

### Solution to Problem

According to an embodiment of the present disclosure, a network function (NF) device includes: a memory including instructions; and a processor configured to execute the instructions to receive a request from a first NF, and during inter-NF call processing according to the request, perform the call processing with a second NF based on NF power information shared between NFs.

Specifically, the first NF and the second NF may include a terminal (UENF), a base station (RANF), and core NFs of a control plane and a user plane.

Specifically, the request from the first NF may include a service request for network access or session control of a terminal, and during an inter-NF call processing for the network access or session control according to the service request, the processor may, based on the shared NF power information, select the second NF and execute a power mode command for at least one of the terminal and the second NF.

Specifically, the NF power information is information obtained by measuring or predicting power of software and hardware components required to perform respective features in the NFs according to NF types, and may include at least one of information on total power required for the NFs and information on partial power required for the respective features in the NFs.

Specifically, sharing of the power information between the NFs may be performed in a request/response scheme or a subscription/notification scheme via communication on the control plane or communication on the user plane between the NFs.

Specifically, if a failure response is received after executing the power mode command, the processor may re-execute the power mode command adjusted according to the failure response.

Specifically, the power mode command may be a command causing the terminal or the second NF, which is a subject to execute the power mode command, to configure a power mode according to power consumption during the inter-NF call processing.

According to an embodiment of the present disclosure, a network function (NF) device includes: a memory including instructions; and a processor configured to execute the instructions to receive a power mode command, and determine whether execution according to the power mode command is possible and respond with at least one of a determination result and an execution result.

According to an embodiment of the present disclosure, a terminal device may include: a memory including instructions; and a processor configured to execute the instructions to transfer a service request for network access or session control to a specific network function (NF), and receive network access or session control using an NF and a power mode that are selected based on NF power information shared between NFs during inter-NF call processing by the specific NF according to the service request.

Specifically, the processor may receive a power mode command from the specific NF, and determine whether execution according to the power mode command is possible, and respond with at least one of a determination result and an execution result.

According to an embodiment of the present disclosure, a power optimization method performed by a network function (NF) includes: receiving a request from a first NF; and during inter-NF call processing according to the request, performing the call processing with a second NF based on NF power information shared between NFs.

Specifically, the request from the first NF may include a service request for network access or session control of a terminal, and the call processing may include, during an inter-NF call processing for the network access or session control according to the service request, selecting the second NF and executing a power mode command for at least one of the terminal and the second NF, based on the shared NF power information.

According to an embodiment of the present disclosure, a power optimization method performed by a network function (NF) includes: receiving a power mode command; and performing command execution of determining whether execution according to the power mode command is possible, and responding with at least one of a determination result and an execution result.

### Advantageous Effects of Invention

According to embodiments of the present disclosure, a technical configuration is implemented to enable optimization of power and resources of each NF via power information sharing between NFs.

Accordingly, the present disclosure derives effects of achieving power efficiency and ESG by optimizing power and resources of each NF according to NF features/purposes, effects of ensuring a service quality according to overall power requirements, and the like.

### BRIEF DESCRIPTION OF DRAWINGS

FIG. 1 is a diagram of an example illustrating a conventional scheme of controlling NF resources.

FIG. 2 illustrates an example of achieving power efficiency by applying the present disclosure.

FIG. 3 is a block diagram showing a configuration of an NF device according to an embodiment of the present disclosure.

FIG. 4 is a diagram of an example illustrating an overall structure to which the present disclosure is applied.

FIG. 5 illustrates an example of selecting a network via power information sharing between NFs according to the present disclosure.

FIGS. 6 and 7 are diagrams showing embodiments of executing a power mode command via power information sharing between NFs according to the present disclosure.

FIGS. 8 to 11 are embodiments showing a call flow according to a power optimization method performed in an NF of the present disclosure.

### MODE FOR CARRYING OUT THE INVENTION

Hereinafter, various embodiments of the present disclosure will be described with reference to the accompanying drawings.

The present disclosure relates to a technology capable of optimizing power and resources of a network function (NF).

In 5G, a network structure for supporting a UE, a base station (access), a core, and a server in an end-to-end manner is defined, and a network structure, in which control signaling and data transmission/reception functions that were jointly performed by a single node (e.g., S-GW, P-GW, etc.) in conventional LTE (4G) are divided and classified into a control plane for control signaling function and a user plane for data transmission/reception functions, is defined.

In this case, in 5G, control plane (CP) nodes may be defined as an access and mobility management function (AMF) that controls radio access of a UE, a policy control function (PCF) that manages/controls UE information and UE-specific policies, such as subscription service information and charging, a session management function (SMF) that controls/manages a session for data service use for each UE, a network exposure function (NEF) responsible for a feature of sharing information with an external network, a unified data management/authentication function (UDM/AUSF) that manages/controls a subscriber DB and authentication of a user, a network repository function (NRF) having a feature of managing/controlling information on respective network functions (NFs) within a network, a charging function (CHF) that processes charging of a subscriber, and a network data analytics function (NWDAF) that collects and analyzes various network data.

In 5G, a user plane (UP) node may be defined as a user plane function (UPF) that transmits and receives data between a UE and a server in an external service network (e.g., the Internet) via a session with the UE under control of (interworking with) an SMF.

In such a 5G system, a control node of a control plane and a data node of a user plane may collectively be referred to as a network function (NF).

That is, in 5G, network functions (NFs) that perform specific features on a control plane and on a user plane are defined, and it is defined to perform interworking between the NFs via a service-based interface (SBI).

In B5G/6G networks, a large number of network functions (NFs) exist, and a large amount of signaling is generated by communications processed based on a service-based interface (SBI) protocol between NFs.

UEs, base stations, and core equipment of B5G/6G are evolving into virtualization and cloud-native NFs (CNFs). Accordingly, CNFs are implemented so as to be easily loaded and operated in a common HW pool (general-purpose server).

Recently, as environmental, social, and governance (ESG) factors have gained importance, power reduction and optimization have become essential elements in B5G and 6G communication equipment.

As part of this, various technologies have been developed in recent general-purpose servers to reduce power consumption, and functions for real-time power control have been commercialized to a considerable extent. For example, via a function of dynamically adjusting a CPU frequency according to a CPU load, energy consumption of common HW can be changed or adjusted in real time.

For reference, the energy consumption of common HW may be caused by all or some of components constituting the HW. For example, the energy consumption may be caused by CPU, memory, NIC, SSD/HDD disk, FPGA, GPU, ASIC chipset, I/O accelerator, main board, and power supply unit constituting a server.

The common HW may refer to rackmount, power modulation, KVM, and display units constituting such servers. That is, NFs (UE, base station, and core system) are functions configured based on the common HW, and consume energy for each NF domain.

However, in the role of efficiently managing/controlling/distributing (and adjusting) resources in UEs, base stations, and core systems, power consumption cannot be considered as a criterion. Accordingly, there are various requirements for energy (i.e., power amount=wattage).

For reference, energy/wattage in the present disclosure may be interpreted variously, such as energy consumption, utilization, and usage and power consumption, utilization, and usage.

However, in B5G/6G mobile communication standards, there are no discussions/measures regarding sharing of wattage.

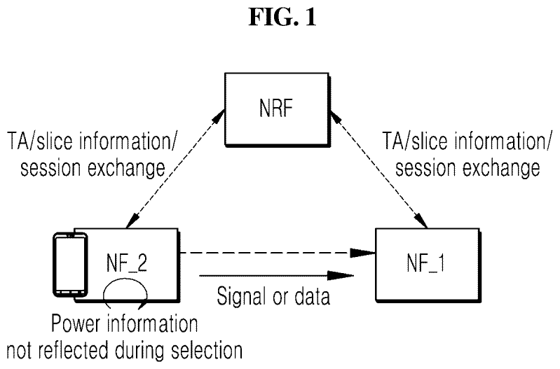

Referring to FIG. 1, current NFs communicate via standard interfaces between the NFs, but there is no operation of performing power-related saving.

That is, conventionally, each NF performs power saving based on its own determination, and there is no sharing method for providing/receiving power information between a UE and a core or between a base station and a core. In other words, conventionally, power information is not exchanged during inter-NF communication.

According to current standard operations and implementations, as illustrated in FIG. 1, when NF_2 (e.g., SMF) selects NF_2 (e.g., UPF) via a request/response to/from an NRF, selection/scheduling is performed by considering multiple elements, such as location (TA), slice information, and session information, for example, DNN, SNSSAI, data network access identifier (DNAI), UE IP, and routing indicator, but information (power information), such as performance including wattage consumed for each NF, is not considered during NF selection and scheduling.

Therefore, according to the current standard operations and implementations, power saving of NFs is performed only at the level of each individual NF.

Consequently, according to the current standard operations and implementations, since there is no scheme/technique for power information sharing between a UE, a base station, and a core, a service quality according to overall power requirements cannot be ensured.

In order to solve this problem, the present disclosure is to realize a new technical solution that enables optimization of power and resources of each NF via power information sharing between NFs.

Accordingly, the present disclosure is to derive effects of achieving power efficiency and ESG by optimizing power and resources of each NF according to NF features/purposes, effects of ensuring a service quality according to overall power requirements, and the like.

The core of the new technical solution proposed in the present disclosure is performing “dynamic power saving” by using information (power information), such as performance including wattage of NFS, during selection of NFs and service producers.

The present disclosure may be applied to all mobile communication NSA/SA and B5G/6G NF equipment and UEs, i.e., a UE (UENF), a base station (RANF), and a core (CNF).

That is, the core feature of the present disclosure is in a configuration in which, when performing call processing between NFs including a UE (UENF), the call processing may be performed based on power information shared between the NFS.

For reference, power information may be interpreted as NF's energy-related information, energy consumption information, etc.

Accordingly, in the present disclosure, power information (PI) may be further used in addition to previously used session information (e.g., TA/NW slice/DNN/APN, etc.) via NF→NRF, and may be considered during NF selection and scheduling.

In this regard, an operation example will be described. According to the present disclosure, when a specific NF has a low wattage in consideration of its consumed wattage based on shared power information (PI), it may be determined that a capacity of the NF may be increased to improve throughput, and a configuration of the NF may be changed, or a consumer NF may be made to recognize that the capacity of the specific NF is sufficient, so that more call processing may be directed to the NF.

Conversely, according to the present disclosure, when a specific NF has a high wattage in consideration of its consumed wattage based on shared power information (PI), in order to prevent excessive power consumption, a configuration may be changed to reduce a capacity of the NF or call processing incoming to the NF may be rerouted to another NF, thereby adjusting wattage consumed by the corresponding equipment/system.

Furthermore, in the present disclosure, power information (PI) may finally be applied as a power mode command (PMC) via determination.

For example, the UE may configure optimized power throughout the core system according to a selection logic and/or power mode command (PMC) reflecting the power information (PI).

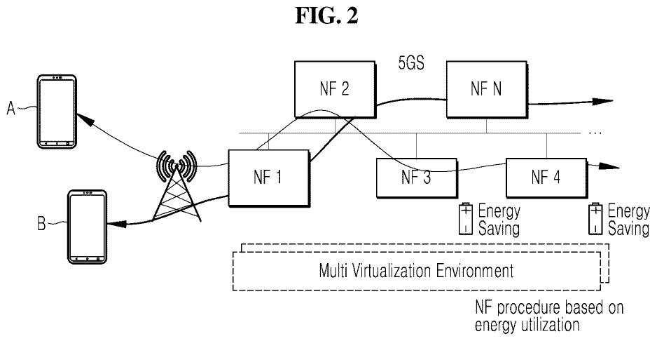

In addition, referring to FIG. 2, another operation example will be described. According to the present disclosure, when a network between a UENF and a core NF is selected, the selection may be performed according to power information (PI)/power mode commands (PMCs) of the two NFs.

In this regard, according to the present disclosure, for each of UEs (UENFs) A and B subscribed to different services, “dynamic power saving” may be performed by a scheme of selecting/routing NFs 1, 2, 3, and 4 for a session (call processing) of UE (UENF) A to save energy throughout the core system, and selecting/routing NFs 1, 2, and N for a session (call processing) of UE (UENF) B, according to individual or group power efficiency requirements and policies of NF features/usages corresponding to the subscribed services.

Hereinafter, a configuration of an NF device according to an embodiment of the present disclosure will be described in detail.

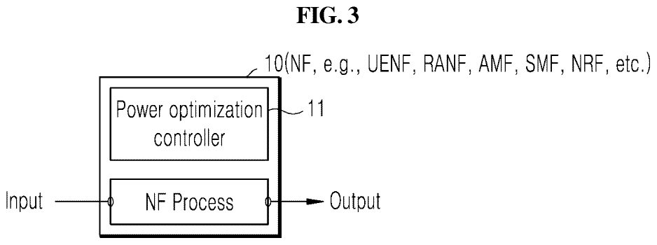

FIG. 3 shows a configuration of an NF device according to an embodiment of the present disclosure.

First, referring to FIG. 3, descriptions will be provided from the aspect of an NF that performs call processing based on NF power information (PI) shared between NFs.

An NF device 10 according to an embodiment of the present disclosure may include a memory (not illustrated) including instructions, and a processor (hereinafter, a power optimization controller 11) configured to, by executing the instructions, receive a request from a first NF, and during inter-NF call processing according to the request, perform the call processing with a second NF based on NF power information shared between NFs.

As mentioned above, the present disclosure may be applied to NFs (e.g., UENF, RANF, AMF, SMF, UPF, etc.) as functional units in UEs (UENFs), base stations (RANFs), and core NFs in all mobile communication domains.

Therefore, the first NF, the second NF, and the NF device 10 described above may be a UE (UENF), a base station (RANF), or a core NF of a control plane or a user plane.

However, in the following description, for convenience of description, an embodiment in which the NF device 10 is a core NF will be described.

First, a scheme of sharing power information (PI) between NFs will be described.

In the present disclosure, power information (PI) sharing between NFs may be performed via communication on a control plane or on a user plane between the NFs according to a request/response scheme or a subscription/notification scheme.

In addition, in the present disclosure, power information (PI) of an NF may be information obtained by measuring or predicting power of software and hardware components required for performing each feature within the NF for each NF type.

In the present disclosure, the power information (PI) of the NF may include at least one of information on the total power required for the NF and information on partial power required for each feature within the NF.

More specifically, in the present disclosure, the power information (PI) may refer to power-related information, such as performance including power amount (wattage).

This power information (PI) is information individually measured or predicted in NF devices 10 (e.g., UENF, RANF, AMF, SMF, UPF, etc.), and thus may be power information (PI) of a UE (UENF), power information (PI) of a base station (RANF), or power information (PI) of a core NF.

For example, when describing a case where the NF type is the UE (UENF) 10, the power information (PI) of the UE (UENF) 10 may be classified/configured according to a device type, a hardware component, and a software component (applied to the base station (RANF) and the core NF in the same manner).

In addition, in the present disclosure, the power information (PI) may refer to information on power consumption for each of various components.

For example, when describing a case where the NF type is the UE (UENF) 10, the power information (PI) of the UE (UENF) 10 may indicate each feature/function of the UE (UENF) 10, and may refer to wattage (power consumption) used for each feature/function. That is, the power information (PI) is information on power used according to various component combinations and roles.

Examples in Table 1 below show power usage according to combinations of software and hardware components required for various features/functions of the UE (UENF) 10.

TABLE 1
Power Information(PI)

| | | Hard- | Hard- | | | | Soft- | Soft- | Soft- | Soft- | Soft- | | Power |
|---|---|---|---|---|---|---|---|---|---|---|---|---|---|
| | Type, | ware | ware | Hardware | Hardware | | ware | ware | ware | ware | ware | | Usage |
| PI ID | Function | info #1 | info #2 | info #3 | info #4 | . . . | info #1 | info #2 | info #3 | info #4 | info #5 | | (Sum) |
| ID #1 | UENF | (CPU = | 32 GB | Display | CPU Freq | . . . | OS | Available | Capa- | App | Visual | . . . | 45 |
| | (NR Mode) | ARMv1) | | (Res, Freq, | (High-Low) | | version | Apps | bility | auto | effect | | |
| | | | | Bright- | | | | | | update | | | |
| | | | | ness . . . ) | | | | | | On/Off | | | |
| ID #2 | UENF | (CPU = | 128 GB | Display | CPU Freq | . . . | OS | Available | Capa- | App | Visual | . . . | 68 |
| | (NR Mode) | ARMv2) | | (Res, Freq, | (High-Low) | | version | Apps | bility | auto | effect | | |
| | | | | Bright- | | | | | | update | | | |
| | | | | ness . . . ) | | | | | | On/Off | | | |
| ID #3 | UENF | (CPU = | 24 GB | Display | CPU Freq | . . . | OS | Available | Capa- | App | Visual | . . . | 50 |
| | (Any) | ARMv3) | | (Res, Freq, | High-Low) | | version | Apps | bility | auto | effect | | |
| | | | | Bright- | | | | | | update | | | |
| | | | | ness . . . ) | | | | | | On/Off | | | |
| . . . | | | | | | | | | | | | . . . | |
| ID #3 | . . . | . . . | . . . | . . . | . . . | . . . | | . . . | . . . | | | . . . | . . . |

Consequently, the power information (PI) expressed in Table 1 may be considered as power required when the specific NF 10 (e.g., UENF, RANF, AMF, SMF, UPF, etc.) performs its role.

That is, each NF 10 (e.g., UENF, RANF, AMF, SMF, UPF, etc.) to which the present disclosure is applied may periodically measure/predict its own power information (PI), and for the UE (UENF) 10, measurement/prediction may be performed in a UE-triggered or network-triggered manner, and information sharing may be performed.

In this case, each NF 10 (e.g., UENF, RANF, AMF, SMF, UPF, etc.) may, for each feature/function, measure/configure power information (PI) by measuring power consumption for past N hours or predict/configure power information (PI) by predicting power consumption for future N+ hours according to the past N hours and/or a current state.

Table 2 below illustrates an example in which the power information (PI) of the NF 10 described above may be differently configured/set for each NF type.

TABLE 2

| | | | | | | | | | | | | |
|---|---|---|---|---|---|---|---|---|---|---|---|---|
| | | | | | | | Soft- | | Soft- | | | Power |
| PI | Type, | Hardware | Hardware | Hardware | Hardware | | ware | Software | ware | Software | | Usage |
| Index | Function | info #1 | info #2 | info #3 | info #4 | . . . | info #1 | info #2 | info #3 | info #4 | . . . | (Sum) |

UENF

| | | | | | | | | | | | | |
|---|---|---|---|---|---|---|---|---|---|---|---|---|
| PI #1 | UENF | (CPU = snap | 32 GB | Disp [symbol] ay | CPU Freq | . . . | OS | Available | Capa- | App | . . . | 45 |
| | (LTE Mode) | dragon) | | (Res, Freq, | (High-Low) | | version | Apps | bility | auto | | |
| | | | | Bright- | | | | | | up [symbol] ate | | |
| | | | | ness . . . ) | | | | | | On/Off | | |

RANF

| | | | | | | | | | | | | |
|---|---|---|---|---|---|---|---|---|---|---|---|---|
| PI #1 | RANF | (CPU = | 32 GB | BIOS | CPU Freq | . . . | OS | Available | Capa- | Sleep Mode | . . . | 60 |
| | (SA Mode) | Intel) | | (C-state . . . ) | (High-Low) | | version | POD/VM | bility | On/Off | | |

Core NF

| | | | | | | | | | | | | |
|---|---|---|---|---|---|---|---|---|---|---|---|---|
| PI #1 | CORENF | (CPU = | 32 GB | BIOS | CPU Freq | . . . | OS | Available | Capa- | Sleep Mode | . . . | 60 |
| | (NSA Mode) | AMD) | | (C-state . . . ) | (High-Low) | | version | POD/VM | bility | On/Off | | |

[symbol]

indicates data missing or illegible when filed

As described above, in the present disclosure, the power information (PI) of the NF 10 may be variously/differently configured/set according to an NF type. That is, the UE (UENF), the base station (RANF), and the core NF may measure/extract information having different characteristics to configure power information (PI).

For example, as shown in Table 2, for the UE (UENF), the power information (PI) may be configured using information on power-related features only for the UE (UENF), such as display setting and ON/OFF of a function such as automatic app update. Alternatively, for the base station (RANF), the core NF, etc., the power information (PI) may be configured using information, such as BIOS setting and CPU frequency of a general-purpose server.

As such, in the present disclosure, the power information (PI) is information obtained for each NF type (device type) by measuring or predicting power of software and hardware components required for performing each feature/function of the specific NF device 10 (e.g., UENF, RANF, AMF, SMF, UPF, etc.).

Further, in the disclosure, the power information (PI) may include at least one of information on total power (total wattage) required for the specific NF device 10 (e.g., UENF, RANF, AMF, SMF, UPF, etc.) and information on partial power (wattage for each feature/function) required for each feature/function within the NF.

In the present disclosure, the power information (PI) of each NF device 10 (e.g., UENF, RANF, AMF, SMF, UPF, . . . ) configured as described above may be shared by request/response in a request/response scheme or a subscription/notification scheme, via communication between the NFs on the control plane or on the user plane.

As described above, when describing by referring to the core NF (e.g., SMF) as the NF 10 to which the present disclosure is applied, the power optimization controller 11 may, upon reception of a request from the first NF, during inter-NF call processing according to the received request, perform the call processing with the second NF based on the NF power information (PI) shared between the NFs.

As a specific embodiment, a case where the request from the first NF is a service request for network access or session control of the UE will be described.

In this embodiment, the processor of the NF 10 (e.g., SMF) to which the present disclosure is applied, i.e., the power optimization controller 11, may perform, via an internal NF process, inter-NF call processing for network access or session control according to the service request (input) received from the first NF.

In this case, during the inter-NF call processing for network access or session control performed via the internal NF process, the power optimization controller 11 may select the second NF based on the NF power information (PI) shared between the NFs and may execute a power mode command for at least one of the UE and the second NF.

Here, the power mode command (PMC) is a command for performing control, such as configuration or changing of an actual power mode/power information (PI) for NF.

More specifically, in the present disclosure, the power mode command (PMC) may refer to a command causing a power mode to be configured for the UE or the second NF subject to execution of the power mode command, the power mode being based on power consumption during the inter-NF call processing.

That is, from the aspect of performing call processing based on the power information (PI), the NF 10 (e.g., SMF) may, based on its own determination or, if necessary, based on interworking/analysis results associated with another core NF and NWDAF, transfer the power mode command (PMC) to the UE subject to network access or session control and/or the second NF selected based on the power information (PI), and perform control, such as configuring or changing an actual power mode/power information (PI) of the UE and/or the second NF.

Subsequently, referring to FIG. 3, descriptions will be provided from the aspect of an NF receiving a power mode command (PMC) based on NF power information (PI) shared between NFs.

The NF device 10 according to an embodiment of the present disclosure may include a memory (not illustrated) including instructions, and a processor (hereinafter, the power optimization controller 11) configured to, by executing the instructions, receive a power mode command (PMC), determine whether execution according to the power mode command (PMC) is possible, and respond with at least one of a determination result and an execution result.

As mentioned above, the present disclosure may be applied to NFs (e.g., UENF, RANF, AMF, SMF, UPF, etc.) as functional units in UEs (UENFs), base stations (RANFs), and core NFs in all mobile communication domains.

Therefore, the NF device 10 of the present disclosure may be a UE (UENF), a base station (RANF), or a core NF of a control plane or a user plane.

However, in the following description, for convenience of description, an embodiment in which UENF is mentioned as the NF device 10 in the aspect of an NF receiving a power information (PI)-based power mode command (PMC) will be described in detail.

That is, the power optimization controller 11 may periodically measure/predict its own power information (PI), and may transfer the power information (PI) in a request/response scheme or a subscription/notification scheme via communication between the NFs on the control plane or on the user plane, so that the power information (PI) may be shared between the NFs.

In addition, when a power mode command (PMC) is transferred by another NF 10 (e.g., SMF) to which the present disclosure is applied, the power optimization controller 11 may determine whether execution according to the power mode command (PMC) is possible, and may respond with at least one of a determination result and an execution result.

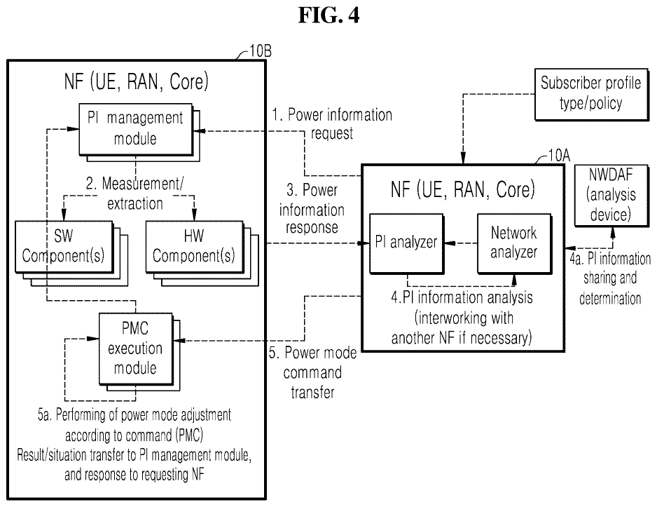

Referring to FIG. 4, descriptions will be provided for an overall structure to which the present disclosure is applied as described above.

As illustrated in FIG. 4, the NF 10 to which the present disclosure is applied may be a UE (UENF), a base station (RANF), or a core NF.

In FIG. 4, a right NF 10A is assumed to be an NF in the aspect of performing call processing based on power information (PI). In FIG. 4, a left NF 10B is assumed to be an NF in the aspect of receiving a power mode command (PMC) based on power information (PI).

As illustrated in FIG. 4, the NF 10A may receive and hold a profile type and a UE policy for a subscriber (e.g., user/service requirements, mobility, specific cell/area entering state, adjustment/(re) selection conditions for thresholds, etc.).

In the present disclosure, the NF 10A may request (1) power information (PI) from the NF 10B.

In this case, a PI management module of the NF 10B may, for each feature/function thereof, internally measure/extract (2) power of software and hardware components required for execution, and respond (3) with power information (PI) configured using the measured/extracted power.

A PI analyzer of the NF 10A may receive and share the power information (PI) of NF 10B. The PI analyzer of the NF 10A may transfer (5) a power mode command (PMC) to the NF 10B, based on its own determination (4) made by analyzing the shared power information (PI) or, if necessary, based on interworking/analysis results (4a) associated with another NF (e.g., core NF, NWDAF, etc.) (PI information sharing and determination).

Then, a PMC execution module of the NF 10B may perform control to configure or change a power mode within the NF 10B according to the power mode command (PMC), and may transfer a result of the control to the PI management module so as to respond the result to the NF 10A.

The PI analyzer and network analyzer of the NF 10A, and the PI management module and PMC execution module of the NF 10B may all be implemented in one NF 10 (e.g., UENF, RANF, AMF, SMF, UPF, etc.) and may be implemented by the power optimization control unit 11 described above.

For further descriptions, the NWDAF may include a business support system/operational support system and O&M (BSS/OSS) responsible for business/operation and management, a data collection coordination function (DCCF) responsible for storage and connection messages, an analytics data repository function (ADRF), a messaging framework adapter function (MFAF), a management data analytics service (MDAS), and an analytics logical function (AnLF) and a model training logical function (MTLF) responsible for AI/ML. In the present disclosure, it may be assumed that the NWDAF comprehensively performs the features above.

Here, the NWDAF proposed in the present disclosure may have each or both of a federated/distributed learning model and a centralized model.

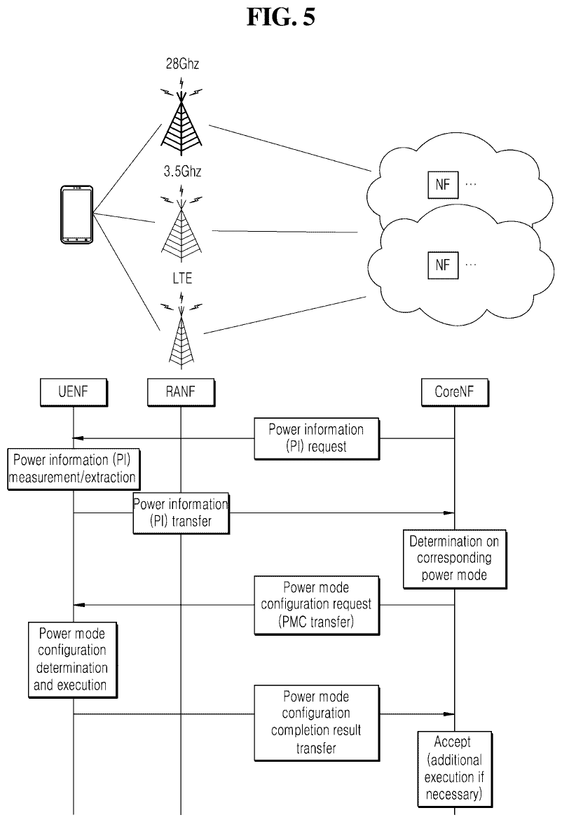

FIG. 5 illustrates an example of selecting a network via power information sharing between NFs according to the present disclosure.

Referring to FIG. 5, a UE (UENF) to which the present disclosure is applied may transfer its power information (PI) to a core network, and the core network may determine a state of the UE (UENF) and then transfer connection information of the UE (UENF).

For example, the following information may be included in 3GPP non-access stratum (NAS) and service-based interface (SBI) messages between the UE (UENF) and an AMF/MME
Handover (H/O) determination (source→target base station recommendation-power information considered)
Conditional H/O information transfer of UE
Power mode configuration of UE (battery saving, low-power, medium-power, max power, etc.)
Performance mode configuration of UE for each specific app (App1-max performance, App2=low performance)
Modification of frequency information associated with UE, and generation fallback trigger
Specific sensor mode configuration of UE (haptic, display, and sound)
Radio resource and scheduling mode configuration of UE (radio resource block and RB scheduling)
Authentication/registration and session execution of UE (UE (re) authentication/registration, UE (re) attachment, (de) attachment, UE PDU session (re) establishment/modification/deletion)

The UE (UENF) and the core NF may share power information (PI) thereof with each other, and in FIG. 5, the UE (UENF) transfers its power information (PI) to the core network (core NF).

This sharing may be performed in a UE-triggered or network-triggered scheme, and FIG. 5 describes a scheme in which the core NF requests power information (PI) from the UE (UENF).

For example, a base station or network for connection may be selected based on information related to a specific UE profile (energy usage) during initial authentication/registration of the UE, and may be selected differently based on the energy usage also during PDU session registration/modification/deletion of the UE.

In this case, the UE (UENF) measures and extracts its power information (PI) and transfers the power information (PI) to the core NF that has requested the same (e.g., NAS and SBI channels between the UE and the AMF/MME).

The core NF may autonomously determine a power mode state of the UE (UENF) based on the transferred/shared power information (PI) of the UE (UENF) or, if necessary, via interworking with another NF (e.g., the core NF, NWDAF, etc.), and may determine how to use the power mode of the UE (UENF).

In addition, according to the determination, the core NF may transfer a power mode command (PMC) to the UE (UENF) and request configuration, change, etc. of the power mode/power information (PI).

Thereafter, the UE (UENF) may determine whether configuration control/execution of the power mode according to the power mode command (PMC) is possible, and proceed with the configuration control/execution based on the determination, wherein, if impossible, the UE (UENF) may respond with a corresponding determination result, and if possible, the UE (UENF) may complete the configuration control/execution of the power mode and then transfer (respond with) a corresponding result.

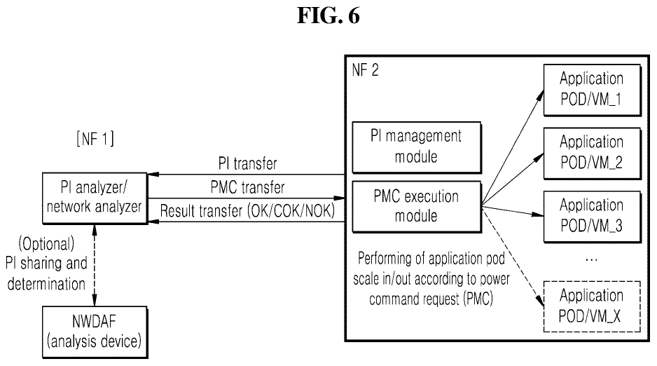

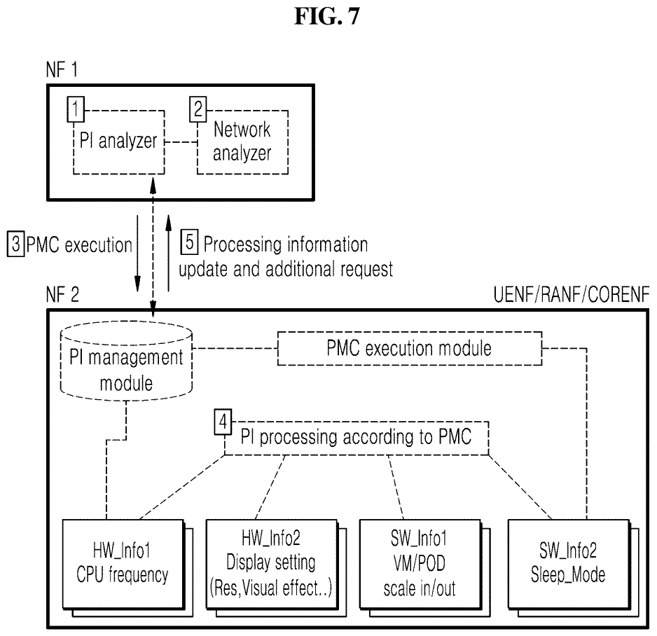

Hereinafter, referring to FIGS. 6 and 7, descriptions will be provided for an embodiment of executing a power mode command (PMC) via power information (PI) sharing between NFs according to the disclosure.

First, descriptions will be provided with reference to FIG. 6.

NFs 1 and 2 are both NFs 10 (e.g., UENF, RANF, AMF, SMF, UPF, etc.) to which the present disclosure is applied, and FIG. 6 shows an embodiment of micro-service NF/pod adjustment as an example of executing a power mode command (PMC).

As illustrated in FIG. 6, when power information (PI) of NF 2 is transferred from NF 2, NF 1 may respond with a power mode command (PMC) to NF 2 via an internal PI analyzer/network analyzer of NF 1.

In this case, NF 1 may optionally utilize an NWDAF and delegate PI sharing and determination to the NWDAF.

For NF 2 having received the power mode command (PMC), an internal PI management module/PMC execution module of NF 2 may execute the power mode command (PMC) by scaling in/out application pods/VMs according to the power mode command (PMC).

That is, when a low wattage is determined based on the power information (PI) of NF 2, NF 1 may transfer a power mode command (PMC) to scale out pods/VMs so as to increase capacity of NF 2, and when a high wattage is determined, NF 1 may transfer a power mode command (PMC) to reduce the capacity of NF 2.

In addition, NF 2 that has received the power mode command (PMC) may transfer/respond with an OK/COK/NOK result to NF 1 according to execution of the power mode command (PMC). In particular, COK is a response/reply for a case where NF 1 has received the power mode command (PMC) but has failed to execute the same (for example, configuration control/execution of the power mode according to the PMC is impossible).

Accordingly, NF 1 (the power optimization controller 11) may transfer the power mode command (PMC) to NF 2, and after NF 2 executes the PMC, if a failure response (COK) is received, NF 1 may re-execute the power mode command after adjustment according to the failure response (COK).

For example, NF 2 having received the power mode command (PMC) may determine whether control/execution of configuration or change of the power mode according to the power mode command (PMC) is possible, and if it is determined to be possible, NF 2 may proceed with executing the power mode command (PMC) and transfer (respond with) a result of the execution to NF 1.

FIG. 6 shows an embodiment in which NF 2 having received the power mode command (PMC) performs application pod scale in/out according to the power mode command (PMC).

If NF 2 determines that the power mode command (PMC) is not at a level executable/acceptable by NF 2, for example, if it is determined that control/execution of configuration or change of the power mode according to the power mode command (PMC) is impossible, NF 2 may respond with a determination result indicating impossibility and a failure response (COK).

Then, upon receiving the determination result indicating impossibility and the failure response (COK), NF 1 may re-execute the power mode command (PMC) after adjustment to a level executable/acceptable by NF 2.

Here, “adjusting to the executable/acceptable level” is based on that the NF (e.g., NF 2) subject to execution of the power mode command (PMC) transfers the determination result and failure response (COK) indicating that the power mode command (PMC) cannot be executed/accepted.

Accordingly, “adjusting to the executable/acceptable level” may refer to transferring feedback that enables re-execution of the power mode command (PMC) after adjustment to the executable/acceptable level, such as proposing a range of the power mode/power information (PI) to be at a level executable/acceptable by the NF (e.g., NF 2) and proposing a change of an execution time point of the power mode command (PMC) via transferring of a backoff timer.

Subsequently, when describing by referring to FIG. 7, NFs 1 and 2 are both NFs 10 (e.g., UENF, RANF, AMF, SMF, UPF, etc.) to which the present disclosure is applied, and FIG. 7 shows an embodiment of changing power information (PI) as an example of executing a power mode command (PMC).

As illustrated in FIG. 7, NF 1 may acquire (1) power information (PI) of NF 2 via a service request message, etc.

When the power information (PI) of NF 2 is transferred from NF 2, NF 1 may determine (2), via its internal PI analyzer/network analyzer, whether the power information (PI) of NF 2 needs to be changed, and if a change is needed, NF 1 may respond to NF 2 with/execute a power mode command (PMC) for the change.

NF 2 having received the power mode command (PMC) changes the power information (PI) according to the power mode command (PMC) via the internal PI management module/PMC execution module. In this case, a PI type to be changed may differ depending on an NF 2 type.

For example, if NF 2 is a UE (UENF), the power mode/power information (PI) may be changed according to the requested power mode command (PMC) by changing a display setting, etc., lowering a resolution, changing a display frequency, setting an automatic app update function, or the like.

Alternatively, if NF 2 is a base station (RANF) or a core NF, the power mode/power information (PI) may be changed according to the requested power mode command (PMC) by changing a BIOS setting of a general-purpose server, configuring a sleep mode function, or the like.

As described above, according to the present disclosure, a specific technical configuration enabling “dynamic power saving” to be performed is implemented via a configuration of sharing information (power information (PI)), such as performance including power amount (wattage), between NFs (e.g., UENF, RANF, AMF, SMF, UPF, etc.) and a configuration of, during selection of NFs and service producers, using power information (PI) of each NF and, if necessary, executing a power mode command (PMC) based thereon.

Accordingly, the present disclosure derives effects of achieving power efficiency and ESG by optimizing power and resources of each NF, effects of ensuring a service quality according to overall power requirements, and the like.

Hereinafter, various embodiments of a call flow according to a power optimization method performed by an NF of the present disclosure will be described.

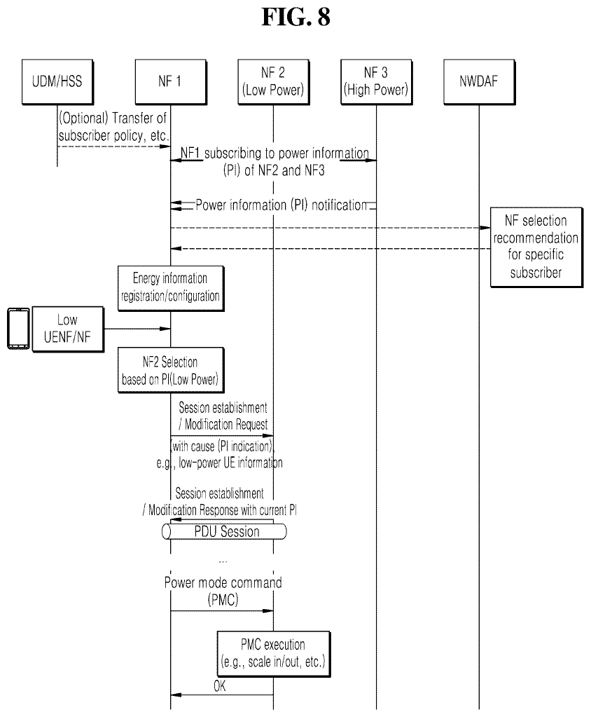

FIGS. 8 to 11 are embodiments showing call flows according to a power optimization method performed in NFs of the present disclosure.

First, FIG. 8 shows an embodiment of a call flow for selecting NFs and service producers based on power information (PI).

That is, the call flow shown in FIG. 8 may be regarded as a basic scenario for sharing power information (PI) between NFs.

Specifically, NF 1 (optionally) receives basic profile information for a subscriber via a UDM/HSS.

In the present disclosure, NF 1 may acquire and receive (via notification) power information (PI) for NFs 2 and 3 requested in advance (via subscription).

Accordingly, in the present disclosure, NF 1 may identify, based on the shared power information (PI), that NF 2 is a device optimized for low power/low performance, and that NF 3 is a device optimized for high power/high performance, and may internally register/configure energy information (power information (PI)).

In addition, in the present disclosure, NF 1 may also share the received power information (PI) of NF 2 and NF 3 with another NF (e.g., NWDAF) so as to (optionally) receive a recommendation for NF selection for a specific subscriber via information analysis.

In the present disclosure, when a service request of a specific subscriber (e.g., a low UENF/NF) is received, NF 1 may perform NF selection for the subscriber based on the previously shared power information (PI) of each NF.

For example, if the UE (UENF) of the subscriber is a low-power UE, NF 1 may select an NF optimized for low power/low performance, for example, NF 2, and may request session control (e.g., session establishment/modification request) according to the service request.

In this case, in the present disclosure, when requesting session establishment/modification/deletion, NF 1 may transfer cause information including the power information (PI) (e.g., low-power UE)/indication.

In the present disclosure, NF 1 may, if necessary, transfer/execute a power mode command (PMC) of the UE (UENF) of the subscriber and/or NF 2.

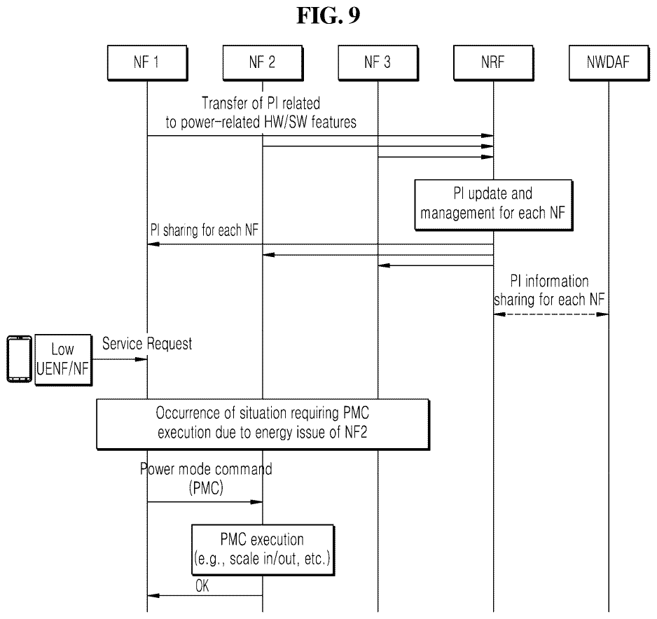

Subsequently, FIG. 9 shows an embodiment of a call flow for executing a power mode command (PMC) based on power information (PI).

The call flow illustrated in FIG. 9 may be regarded as a scenario in which an NRF is involved in power information (PI) sharing between NFs.

Specifically, each of all NFs including NF 1, NF 2, and NF 3 transfers power information (PI) thereof to the NRF.

The NRF may acquire, update, and manage the power information (PI) of each NF, and may transfer the NF-specific power information (PI) to the NFs to allow sharing of the power information (PI). When there is an NWDAF, the NRF may also (optionally) transfer/share the information to/with the NWDAF.

In the present disclosure, when a service request of a specific subscriber (e.g., a low UENF/NF) is received, NF 1 may, based on the previously shared power information (PI) of each NF, select NF 2 having low power/low performance and request session control (e.g., session establishment/modification request) for the subscriber, wherein interworking between NF 1 and NF 2 may fail due to an energy issue of NF 2.

In this case, in the present disclosure, NF 1 may recognize that execution of a power mode command (PMC) for NF 2 is required, and based on the shared power information (PI) of NF 2, NF 1 may transfer, to NF 2, a power mode command (PMC) causing configuration of a power mode according to power consumption during inter-NF call processing (e.g., session establishment) or execute the power mode command (PMC).

Thus, NF 2 may execute the power mode command (PMC) by scaling in/out application pods/VMs, according to the power mode command (PMC) from NF 1.

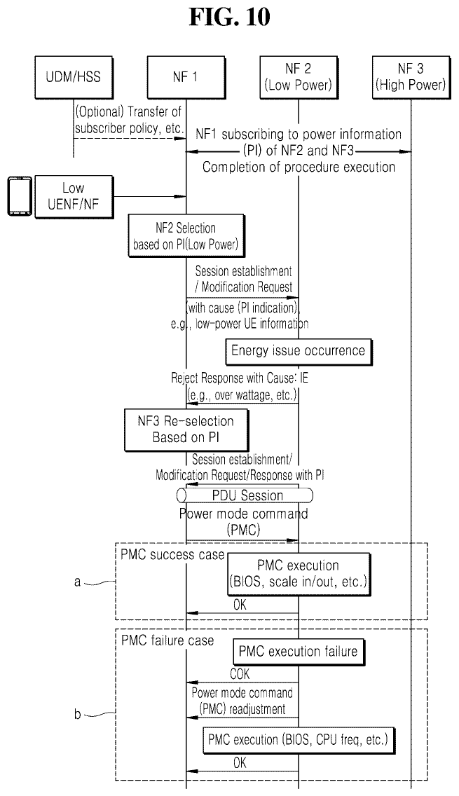

Subsequently, an embodiment of another call flow will be described with reference to FIG. 10.

FIG. 10 shows a call flow in a scheme of selecting NF 2 and NF 3 based on various session states in a CP NF.

Specifically, in the present disclosure, NF 1 may identify that both NF 2 and NF 3 are low-power/low-performance NFs (see FIG. 8).

In addition, in the present disclosure, when a service request of a specific subscriber (e.g., a low UENF/NF) is received, NF 1 may, based on shared power information (PI), select NF 2 and request session control (e.g., a session establishment/modification request) according to the service request.

In this case, the session control request (e.g., session establishment/modification/deletion request) is transferred with cause information including the power information (PI) (e.g., a low-power UE)/indication.

In the present disclosure, if an energy issue occurs in NF 2, and NF 2 cannot respond to the session control request (e.g., session establishment/modification request) of NF 1, NF 2 may transfer a reject response message with a cause (e.g., over wattage).

In the present disclosure, in response to the reject response message (with the cause), NF 1 may select NF 3 by performing NF reselection based on the previously shared power information (PI), and request session control (e.g., session establishment/modification request). Subsequently, a PDU session succeeds.

In the present disclosure, after the PDU session succeeds, NF 1 may transfer a power mode command (PMC) to NF 2 or execute the same so as to resolve the energy issue via power optimization.

In this case, execution of the power mode command (PMC) may be classified into a successful case (a) and a failure case (b).

In the successful case (a) of executing the power mode command (PMC), NF 2 may determine that control/execution of configuration or change of a power mode according to the power mode command (PMC) is possible, proceed with execution of the power mode command (PMC), and transfer (respond with) a result (OK) of the execution to NF 1.

In the failure case (b) of executing the power mode command (PMC), NF 2 may determine that control/execution of configuration or change of the power mode according to the power mode command (PMC) is impossible, and respond with a determination result indicating impossibility and a failure response (COK).

In this case, upon receiving the determination result indicating impossibility and the failure response (COK), NF 1 may re-execute the power mode command (PMC) after adjustment to a level executable/acceptable by NF 2.

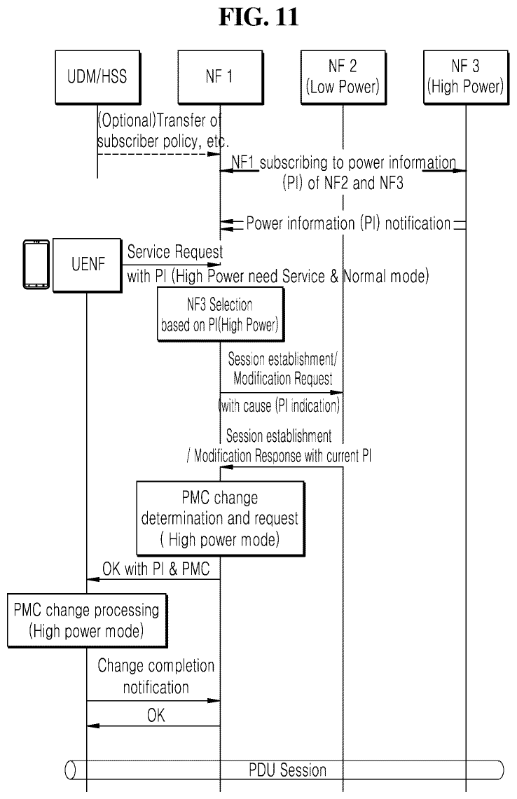

Subsequently, an embodiment of another call flow will be described with reference to FIG. 11.

FIG. 11 shows a scenario of executing a power mode command (PMC) of a UE (UENF).

Referring to FIG. 11, NF 1 may recognize, based on shared power information (PI), that NF 2 is a device optimized for low power/low performance, and NF 3 is a device optimized for high power/high performance.

When a UE (UENF) in a normal power consumption mode (normal mode) transfers, to NF 1, a service request for high power/high performance, such as high-resolution video playback or high-performance gaming, NF 1 may, based on the shared power information (PI), select NF 3 recognized as a high-power/high-performance NF and request session control (e.g., session establishment/modification request) according to the service request (with a cause).

In the present disclosure, NF 1 may determine, based on a state (normal mode) identified from the shared power information (PI) of the UE (UENF) and a determination result according to a session state (high power), a change to a high-power mode is required for the UE (UENF), and in this case, NF 1 may transfer a power mode command (PMC) included in a response (OK message) to the service request.

In this case, according to the power mode command (PMC) from NF 1, the UE (UENF) may change its power mode to a high-power mode, execute the power mode command (PMC), and respond with a corresponding result (completion of the change) to NF 1.

As described above, according to a power optimization method performed in an NF of the present disclosure, a specific technical configuration enabling “dynamic power saving” to be performed is implemented via a configuration of sharing information (power information (PI)), such as performance including power amount (wattage), between NFs (e.g., UENF, RANF, AMF, SMF, UPF, etc.) and a configuration of, during selection of NFs and service producers, using power information (PI) of each NF and, if necessary, executing a power mode command (PMC) based thereon.

Accordingly, the present disclosure derives effects of achieving power efficiency and ESG by optimizing power and resources of each NF, effects of ensuring a service quality according to overall power requirements, and the like.

The power optimization method according to an embodiment of the present disclosure may be implemented in the form of program commands executable via various computer means so as to be recorded in a computer-readable medium. The computer-readable medium may include each of program commands, data files, data structures, etc. or a combination thereof. The program commands recorded in the medium may be specially designed and configured for the present disclosure, or may be known and available to those skilled in the computer software field. Examples of computer-readable recording media include magnetic media such as hard disk, floppy disk, and magnetic tape, optical media such as CD-ROM and DVD, magneto-optical media such as a floptical disk, and a hardware device such as ROM, RAM, and flash memory specially configured to store and execute program commands. Examples of the program commands include high-level language codes executable by a computer using an interpreter, etc., as well as machine language codes produced by a compiler. The aforementioned hardware device may be configured to operate as one or more software modules to perform operations of the present disclosure, and vice versa.

In the present disclosure, descriptions have been provided in detail with reference to various embodiments, but the present disclosure is not limited to the above-described embodiments, and the technical idea of the present disclosure extends to the range in which anyone skilled in the art, to which the present disclosure belongs, can make various changes or modifications without departing from the gist of the present disclosure, which is claimed in the following claims.

1. A network function (NF) device comprising:
a memory comprising instructions; and
a processor configured to execute the instructions to receive a request from a first NF, and during inter-NF call processing according to the request, perform the call processing with a second NF, based on NF power information shared between NFs.

2. The NF device of claim 1, wherein the first NF and the second NF comprise a terminal (UENF), a base station (RANF), and core NFs of a control plane and a user plane.

3. The NF device of claim 1, wherein the request from the first NF comprises a service request for network access or session control of a terminal, and
the processor is configured to, during an inter-NF call processing for the network access or session control according to the service request, select the second NF and execute a power mode command for at least one of the terminal and the second NF, based on the shared NF power information.

4. The NF device of claim 2, wherein the NF power information is information obtained by measuring or predicting power of software and hardware components required to perform respective features in the NFs according to NF types, and comprises at least one of information on total power required for the NFs and information on partial power required for the respective features in the NFs.

5. The NF device of claim 2, wherein sharing of the power information between the NFs is performed in a request/response scheme or a subscription/notification scheme via communication on the control plane or communication on the user plane between the NFs.

6. The NF device of claim 3, wherein the processor is configured to, in case that a failure response is received after executing the power mode command, re-execute the power mode command adjusted according to the failure response.

7. The NF device of claim 3, wherein the power mode command is a command causing the terminal or the second NF, which is a subject to execute the power mode command, to configure a power mode according to power consumption during the inter-NF call processing.

8. A network function (NF) device comprising:
a memory comprising instructions; and
a processor configured to execute the instructions to receive a power mode command, determine whether execution according to the power mode command is possible, and respond with at least one of a determination result and an execution result.

9. A terminal device comprising:
a memory comprising instructions; and
a processor configured to execute the instructions to transfer a service request for network access or session control to a specific network function (NF), and receive network access or session control using an NF and a power mode that are selected based on NF power information shared between NFs during inter-NF call processing by the specific NF according to the service request.

10. The terminal device of claim 9, wherein the processor is configured to receive a power mode command from the specific NF, determine whether execution according to the power mode command is possible, and respond with at least one of a determination result and an execution result.

11. A power optimization method performed by a network function (NF), the method comprising:
receiving a request from a first NF; and
during inter-NF call processing according to the request, performing the call processing with a second NF, based on NF power information shared between NFs.

12. The method of claim 11, wherein the request from the first NF comprises a service request for network access or session control of a terminal, and
the call processing comprises, during an inter-NF call processing for the network access or session control according to the service request, selecting the second NF and executing a power mode command for at least one of the terminal and the second NF, based on the shared NF power information.

13. A power optimization method performed by a network function (NF), the method comprising:
receiving a power mode command; and
performing command execution of determining whether execution according to the power mode command is possible and responding with at least one of a determination result and an execution result.
